(19) United States
(12) Patent Application Publication
(10) Pub. No.: US 2025/0216542 A1
(43) Pub. Date: Jul. 3, 2025

(54) APPARATUS FOR CONTROLLING VEHICLE AND METHOD THEREOF

(71) Applicants: Hyundai Motor Company, Seoul (KR); Kia Corporation, Seoul (KR)

(72) Inventors: Nam Hyung Lee, Hwaseong-SI (KR); Sung Moon Jang, Hwaseong-SI (KR); Hyung Jin Cha, Hwaseong-SI (KR); Dong Hyo Son, Hwaseong-SI (KR); Su Min Jo, Hwaseong-SI (KR); In Sun Lee, Hwaseong-SI (KR)

(21) Appl. No.: 18/891,344

(22) Filed: Sep. 20, 2024

(30) Foreign Application Priority Data
Jan. 2, 2024 (KR) 10-2024-0000336

(51) Int. Cl. G01S 13/72; B60W 60/00; G06V 20/58

(52) U.S. Cl. CPC G01S 13/72; B60W 60/001; G06V 20/58

(57) ABSTRACT

An apparatus for controlling a vehicle is introduced. The apparatus may comprise at least three different type of sensors. The first sensor may obtain visual track information about an external object within an image. The second sensor may provide track information in the form of plots corresponding to the external object. The third sensor may collect track information in clusters of points or virtual boxes corresponding to the external object. The apparatus may set a reference angle range and distance based on the first and second track information. The apparatus then may associate these with the third track information and output a signal for vehicle control.

### CROSS-REFERENCE TO RELATED APPLICATION

This application claims the benefit of priority to Korean Patent Application No. 10-2024-0000336, filed in the Korean Intellectual Property Office on Jan. 2, 2024, the entire contents of which are incorporated herein by reference.

### TECHNICAL FIELD

The present disclosure relates to a vehicle control apparatus and a method thereof, and more particularly, relates to sensor fusion.

### BACKGROUND

Various studies are being conducted to identify an external object by using various sensors to assist the driving of a vehicle.

In particular, while the vehicle is driving in a driving assistance device activation mode or an autonomous driving mode, the external object may be identified by using various sensors (e.g., light detection and ranging (LiDAR), a camera, or radio detection and ranging (RADAR)).

The external object may be identified by fusing pieces of sensor data obtained through the sensors if the external object is identified by using the various sensors.

### SUMMARY

According to the present disclosure, an apparatus for controlling a vehicle, the apparatus may comprise, a first sensor configured to obtain first track information associated with an external object, wherein the first track information may comprise a visual object corresponding to the external object within an image obtained by the first sensor, a second sensor configured to obtain second track information associated with the external object, wherein the second track information may comprise a plot of a plurality of plots obtained by the second sensor, and wherein the plot corresponds to the external object, a third sensor configured to obtain third track information associated with the external object, wherein the third track information may comprise at least one of a cluster of points of a plurality of clusters of points obtained by the third sensor or a virtual box of a plurality of virtual boxes obtained by the third sensor, and wherein the cluster of points or the virtual box correspond to the external object, and a processor, wherein the processor is configured to, set, based on selecting the first sensor as a reference sensor, a reference angle range, set, based on the second track information, a reference distance, associate, based on the reference angle range and the reference distance, at least one of the first track information, the second track information, or the third track information, and output, based on the association, a signal for controlling the vehicle, and wherein the first sensor comprises a camera, the second sensor comprises a radio detection and ranging sensor, and the third sensor comprises a light detection and ranging sensor.

The apparatus, wherein the processor is configured to, determine the plot of the plurality of plots, as a part of the second track information, wherein the plot is included within the reference angle range and is at the closest distance from the vehicle, and associate, based on the determination, the second track information and the first track information.

The apparatus, wherein the processor is configured to, associate, based on determining the third track information, at least one of the third track information, the first track information, or the second track information, wherein the third track information indicates that a third track is included within the reference angle range and within the reference distance.

The apparatus, wherein the processor is configured to, determine a reference angle for setting the reference angle range based on at least one of, a first length between a center of the image and an end of the image, a second length between the center of the image and an end of a first track indicated by the first track information, or a field of view of the first sensor.

The apparatus, wherein the processor is configured to, determine the first track information based on, a first axis parallel to a driving direction of the vehicle, and a second axis perpendicular to the first axis, and determine, based on center coordinates from the first track information, a reference angle for setting the reference angle range.

The apparatus, wherein the processor is configured to, set, based on an angle resolution from the second sensor and center coordinates from the first track information, the reference angle range, and based on determining that a second track, from the second track information, is within the reference angle range from the first track information, associate the first track information and the second track information.

The apparatus, wherein the processor is configured to, set, based on a location resolution associated with the third sensor and a longitudinal distance from the vehicle as indicated by the second track information, the reference distance.

The apparatus, wherein the processor is configured to, set, based on the longitudinal distance being smaller than or equal to a first longitudinal distance, the reference distance as a first reference distance, and set, based on the longitudinal distance exceeding the first longitudinal distance and being smaller than or equal to a second longitudinal distance, the reference distance as a second reference distance exceeding the first reference distance at the second longitudinal distance, by gradually increasing the reference distance from the first reference distance.

The apparatus, wherein the processor is configured to, assign a first identifier to the first track information, wherein the first identifier indicates that the first sensor is the reference sensor, assign a second identifier to the second track information wherein the second identifier indicates that the second sensor is a target sensor different from the reference sensor, and assign the second identifier or a third identifier to the third track information, wherein the second identifier or the third identifier indicate that the third sensor is the target sensor.

The apparatus, wherein the processor is configured to, based on associating the first track information, the second track information, and the third track information, assign, to the first track information, the second track information, and the third track information, at least one of, a sensor flag indicating that the first track information, the second track information, and the third track information are associated, a data structure, or an identifier.

According to the present disclosure, a method for controlling a vehicle, the method may comprise, setting, by a processor and based on selecting a first sensor as a reference sensor, a reference angle range, wherein first track information, obtained from the first sensor, may comprise a visual object corresponding to an external object within an image obtained by the first sensor, setting, based on a second track information obtained from a second sensor, a reference distance, wherein the second track information may comprise a plot of a plurality of plots obtained by the second sensor, and wherein the plot corresponds to the external object, associating, based on the reference angle range and the reference distance, at least one of first track information obtained from the first sensor, the second track information, or third track information obtained from a third sensor, wherein the third track information may comprise at least one of a cluster of points of a plurality of clusters of points obtained by the third sensor or a virtual box of a plurality of virtual boxes obtained by the third sensor, and wherein the cluster of points or the virtual box correspond to the external object, and outputting, based on the associating, a signal for controlling the vehicle.

The method may further comprise, determining the plot of the plurality of plots as a part of the second track information, wherein the plot is included within the reference angle range and is at the closest distance from the vehicle, and associating, based on the determining, the second track information and the first track information.

The method may further comprise, associating, based on determining the third track information, at least one of the third track information, the first track information, or the second track information, wherein the third track information indicates that a third track is included within the reference angle range and within the reference distance.

The method may further comprise, determining a reference angle for setting the reference angle range based on at least one of, a first length between a center of the image and an end of the image, a second length between the center of the image and an end of a first track indicated by the first track information, or a field of view of the first sensor.

The method may further comprise, determining the first track information based on, a first axis parallel to a driving direction of a vehicle, and a second axis perpendicular to the first axis, and determining, based on center coordinates from the first track information, a reference angle for setting the reference angle range.

The method may further comprise, setting, based on an angle resolution from the second sensor and center coordinates from the first track information, the reference angle range, and based on determining that a second track, from the second track information, is within the reference angle range from the first track information, associating the first track information and the second track information.

The method may further comprise, setting, based on a location resolution the third sensor and a longitudinal distance from the vehicle as indicated by the second track information, the reference distance.

The method may further comprise, setting, based on the longitudinal distance being smaller than or equal to a first longitudinal distance, the reference distance as a first reference distance, or setting, based on the longitudinal distance exceeding the first longitudinal distance and being smaller than or equal to a second longitudinal distance, the reference distance as a second reference distance exceeding the first reference distance at the second longitudinal distance, by gradually increasing the reference distance from the first reference distance.

The method may further comprise, assigning a first identifier to the first track information, wherein the first identifier indicates that the first sensor is the reference sensor, and assigning a second identifier to the second track information, wherein the second identifier indicates that the second sensor is a target sensor different from the reference sensor or assigning the second identifier or a third identifier to the third track information, wherein the second identifier or the third identifier indicate that the third sensor is the target sensor.

The method may further comprise, based on associating the first track information, the second track information, and the third track information, assigning, to the first track information, the second track information, and the third track information, at least one of, a sensor flag indicating that the first track information, the second track information, and the third track information are associated, a data structure, or an identifier.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a block diagram associated with a vehicle control apparatus, according to an example of the present disclosure;

FIG. 2 shows an example of a block diagram associated with processing of a track, in an example of the present disclosure;

FIG. 3 shows an example of a block diagram associated with tracks generated by each sensor, in an example of the present disclosure;

FIGS. 4A and 4B show an example for setting a reference angle or reference angle range, in an example of the present disclosure;

FIG. 5 shows an example of associating a camera track and a RADAR track, in an example of the present disclosure;

FIGS. 6A and 6B show an example of setting a reference distance from a RADAR track, in an example of the present disclosure;

FIG. 7 shows an example of performing an association on a camera track, a RADAR track, and a LiDAR track corresponding to an external object, in an example of the present disclosure;

FIG. 8 shows an example of a flowchart associated with a vehicle control method, according to an example of the present disclosure; and

FIG. 9 shows an example of a computing system associated with a vehicle control apparatus or vehicle control method, according to an example of the present disclosure.

### DETAILED DESCRIPTION

Hereinafter, some examples of the present disclosure will be described in detail with reference to the accompanying drawings. In adding reference numerals to components of each drawing, it should be noted that the same components include the same reference numerals, although they are indicated on another drawing. Furthermore, in describing the examples of the present disclosure, detailed descriptions associated with well-known functions or configurations will be omitted if they may make subject matters of the present disclosure unnecessarily obscure.

In describing elements of an example of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It will be understood that terms used herein should be interpreted as including a meaning that is consistent with their meaning in the context of the present disclosure and the relevant art and will not be interpreted in an idealized or overly formal sense unless expressly so defined herein.

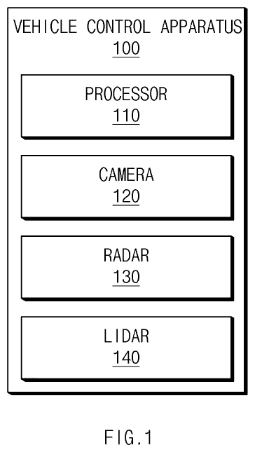

Hereinafter, various examples of the present disclosure will be described in detail with reference to FIGS. 1 to 9.

FIG. 1 shows an example of a block diagram associated with a vehicle control apparatus, according to an example of the present disclosure.

Referring to FIG. 1, a vehicle control apparatus 100 according to an example of the present disclosure may be implemented inside or outside a vehicle, and some of components included in the vehicle control apparatus 100 may be implemented inside or outside the vehicle. At this time, the vehicle control apparatus 100 may be integrated with internal control units of a vehicle and may be implemented with a separate device so as to be coupled with control units of the vehicle by means of a separate connection means. For example, the vehicle control apparatus 100 may further include components not shown in FIG. 1.

According to an example of the present disclosure, the vehicle control apparatus 100 may include a processor 110 and a plurality of sensors comprising at least a first sensor, a second sensor, and a third sensor (e.g., a camera 120, a RADAR 130, and a LiDAR 140). The processor 110, the camera 120, the RADAR 130, or the LiDAR 140 may be electrically and/or operably coupled with each other by an electronic component including a communication bus and/or wirelessly.

Hereinafter, the fact that pieces of hardware are coupled operably may include the fact that a direct and/or indirect connection between the pieces of hardware is established by wired and/or wirelessly such that second hardware is controlled by first hardware among the pieces of hardware.

Although different blocks are shown, an example is not limited thereto. Some of the pieces of hardware in FIG. 1 may be included in a single integrated circuit including a system on a chip (SoC). The type and/or number of hardware included in the vehicle control apparatus 100 is not limited to that shown in FIG. 1. For example, the vehicle control apparatus 100 may include only some of the pieces of hardware shown in FIG. 1.

The vehicle control apparatus 100 according to an example may include hardware for processing data based on one or more instructions. The hardware for processing data may include the processor 110.

For example, the hardware for processing data may include an arithmetic and logic unit (ALU), a floating point unit (FPU), a field programmable gate array (FPGA), a central processing unit (CPU), and/or an application processor (AP).

The processor 110 may include a structure of a single-core processor, or may include a structure of a multi-core processor including a dual core, a quad core, a hexa core, or an octa core.

The camera 120 included in the vehicle control apparatus 100 according to an example may include one or more optical sensors (e.g., a charged coupled device (CCD) sensor or a complementary metal oxide semiconductor (CMOS) sensor) that generate electrical signals indicating the color and/or brightness of light. A plurality of optical sensors (e.g., photodiodes, CCD sensors, CMOS sensors, phototransistors, fiber optic sensors, infrared sensors, color sensors, etc.) included in the camera 120 may be arranged in a form of a 2-dimensional array.

The camera 120 may obtain electrical signals from a plurality of optical sensors substantially simultaneously and may generate images or frames, each of which corresponds to light reaching the 2-dimensional array of optical sensors and each of which includes a plurality of pixels arranged in two dimensions.

For example, photo data captured by using the camera 120 may refer to a plurality of images obtained from the camera 120.

For example, video data captured by using the camera 120 may mean the sequence of a plurality of images obtained from the camera 120 at a designated frame rate.

For example, the processor 110 may identify a visual object corresponding to an external object within an image obtained through the camera 120. For example, the processor 110 may identify a camera track corresponding to an external object. For example, a camera track may include one of the visual objects, to each of which an identifier for tracking an external object is assigned, each of which corresponds to the external object, and each of which is identified within the image.

For example, the RADAR 130 of the vehicle control apparatus 100 according to an example may detect an external object by using electromagnetic (EM) scattering. For example, the RADAR 130 may identify at least one of a distance from the RADAR 130 to an external object, speed, or a shape, or any combination thereof.

For example, the RADAR 130 may generate RADAR plots corresponding to each of external objects, based on electromagnetic waves reflected from external objects. For example, the processor 110 may generate a RADAR track corresponding to a specific external object among the RADAR plots respectively corresponding to the external objects. For example, the RADAR track may include one of the RADAR plots, to each of which an identifier for tracking an external object is assigned.

The LiDAR 140 of the vehicle control apparatus 100 according to an example may obtain data sets from identifying objects surrounding the vehicle control apparatus 100. For example, the LiDAR 140 may identify at least one of a location of the surrounding object, a movement direction of the surrounding object, or speed of the surrounding object, or any combination thereof based on a pulse laser signal emitted from the LiDAR 140 being reflected by the surrounding object and returned.

For example, the LiDAR 140 may obtain data sets for expressing a surrounding external object in the space defined by a first axis (e.g., X-axis parallel to a driving direction of a vehicle), a second axis (e.g., Y-axis perpendicular to the X-axis), and a third axis (e.g., Z-axis perpendicular to the X-axis and the Y-axis) based on a pulse laser signal reflected from surrounding objects.

For example, the LiDAR 140 may obtain data sets including a plurality of points in the space, which is formed by the first axis, the second axis, and the third axis, based on receiving the pulse laser signal at a designated period.

For example, the plurality of points may be clustered into a cluster of points (e.g., a point cloud) corresponding to an external object (or a surrounding object).

For example, the processor 110 may obtain data sets including a plurality of points based on the time required or taken to transmit light emitted from the vehicle and the time required or taken to receive light emitted from the vehicle. The processor 110 may obtain data sets for expressing a plurality of points in a three-dimensional virtual coordinate system including the first axis, the second axis, and the third axis.

For example, the first axis may include the x-axis. For example, the second axis may include the y-axis. For example, the third axis may include the z-axis. For example, the first axis, the second axis, and the third axis may be perpendicular to each other and may intersect each other based on an origin point. The first axis, the second axis, and the third axis are not limited to the above examples. Hereinafter, for convenience of description, the first axis is described as the x-axis; the second axis is described as the y-axis; and the third axis is described as the z-axis.

The camera 120 of the vehicle control apparatus 100 according to an example may obtain a camera track corresponding to an external object. For example, the camera track may include a visual object corresponding to the external object within an image obtained through the camera 120. For example, the camera track may include a visual object, to which an identifier for tracking an external object is assigned, within the image obtained through the camera 120.

The RADAR 130 of the vehicle control apparatus 100 according to an example may obtain a RADAR track corresponding to the external object. For example, the RADAR track may include a RADAR plot corresponding to the external object among the RADAR plots obtained through the RADAR 130. For example, the RADAR track may include a RADAR plot, to which an identifier for tracking the external object is assigned.

The LiDAR 140 of the vehicle control apparatus 100 according to an example may obtain a LiDAR track corresponding to the external object. For example, the LiDAR track may include a point cloud or virtual box, which corresponds to an external object, from among point clouds or virtual boxes obtained through the LiDAR 140. For example, the LiDAR track may include a visual object, to which an identifier for tracking the external object is assigned, in the point cloud or virtual box corresponding to the external object.

In an example, the processor 110 may assign a first identifier indicating that the camera 120 is a reference sensor, to the camera track. The processor 110 may assign a second identifier indicating that the RADAR 130 is a target sensor different from the reference sensor, to the RADAR track. The processor 110 may assign a second identifier or a third identifier indicating that the LiDAR 140 is a target sensor, to the LiDAR track.

The processor 110 of the vehicle control apparatus 100 according to an example may perform an association forming a group of at least one of a camera track, a RADAR track, or a LiDAR track, or any combination thereof.

For example, the performing of the association may include performing an association function (or an association process) of creating a group of at least one of the camera track, the RADAR track, or the LiDAR track, or any combination thereof.

For example, the processor 110 may set a reference angle range for performing an association forming a group of at least one of the camera track, the RADAR track, or the LiDAR track, or any combination thereof based on selecting the camera 120 as the reference sensor.

The processor 110 according to an example may identify the camera track on the first axis expressing a value increasing towards the front of the vehicle, and the second axis expressing a value increasing towards the left side of the vehicle in a vehicle coordinate system expressed based on the vehicle. For example, the first axis may include the x-axis (e.g., x-axis parallel to a driving direction of a vehicle). For example, the second axis may include the y-axis (e.g., y-axis perpendicular to the X-axis).

For example, the processor 110 may identify the center coordinates of the camera track based on identifying the camera track. The processor 110 may calculate a reference angle for setting a reference angle range based on the center coordinates of the camera track.

For example, the processor 110 may calculate or determine the reference angle for setting the reference angle range, based on at least one of a first length between a center of an image obtained through the camera 120 and an end of the image, a second length between the center of the image and an end of the camera track, or a field of view (FOV) of the camera, or any combination thereof.

For example, the center of the image obtained through the camera 120 may include a center line of the image.

In an example, the processor 110 may set the reference angle range based on the angle resolution of the RADAR 130 and the center coordinates of the camera track.

For example, the processor 110 may set the reference angle range rotating clockwise and/or counterclockwise from the reference angle by a designated angle based on the designated angle corresponding to the angle resolution of the RADAR 130. For example, the processor 110 may apply a designated margin to the designated angle corresponding to the angle resolution of the RADAR 130 and then may set the reference angle range rotating clockwise and/or counterclockwise by the designated angle, to which the margin is applied, from the reference angle.

In an example, the processor 110 may identify a RADAR plot, which is included within the reference angle range and which is identified at the closest distance from the vehicle, from among the RADAR plots obtained through the RADAR 130 as a RADAR track. The processor may perform an association on the identified RADAR track and the camera track.

In an example, the processor 110 may perform an association on the camera track and the RADAR track, based on identifying the RADAR track within the reference angle range from the camera track. For example, the processor 110 may assign an identifier indicating that the camera track and the RADAR track correspond to the same external object, based on identifying the RADAR track within the reference angle range from the camera track.

In an example, the processor 110 may set a reference distance from the RADAR track for performing an association on at least one of a camera track, a RADAR track, or a LiDAR track, or any combination thereof, based on the RADAR track.

In an example, the processor 110 may set the reference distance based on the location resolution of the LiDAR 140 and a longitudinal distance from the vehicle of the RADAR track. For example, the processor 110 may identify the longitudinal distance from the vehicle of the RADAR track based on a minimum x coordinate of the RADAR track.

In an example, the processor 110 may set the reference distance as the first reference distance based on the fact that the longitudinal distance from the vehicle of the RADAR track is smaller than or equal to a first longitudinal distance (e.g., about 25-35 m).

In an example, the processor 110 may set the reference distance as a second reference distance exceeding the first reference distance at the second longitudinal distance, by gradually increasing the reference distance from the first reference distance based on the fact that the longitudinal distance from the vehicle of the RADAR track exceeds the first longitudinal distance and is smaller than or equal to the second longitudinal distance (e.g., about 55-65 m).

In an example, the processor 110 may identify a LiDAR track, which is included within a reference angle range and which is included in a reference distance from the RADAR track. The processor 110 may perform an association on at least one of a LiDAR track, a camera track, or a RADAR track, or any combination thereof based on identifying the LiDAR track, which is included within the reference angle range and which is included within the reference distance from the RADAR track.

In an example, the processor 110 may perform an association on at least one of a camera track, a RADAR track, or a LiDAR track, or any combination thereof based on the reference angle range and the reference distance.

In an example, the processor 110 may assign at least one of a sensor flag indicating that the camera track, the RADAR track, and the LiDAR track are associated, a data structure, or an identifier, or any combination thereof to the camera track, the RADAR track, and the LiDAR track based on performing an association on the camera track, the RADAR track, and the LiDAR track.

As described above, the processor 110 of the vehicle control apparatus 100 according to an example may set a reference angle by using the camera 120, may perform the association on the camera track and the RADAR track based on the set reference angle, may set a reference distance by using the RADAR track on which the association is performed, and may perform an association on the LiDAR track, the RADAR track, and the camera track based on the set reference distance. The processor 110 may more accurately identify the distance and location of an external object (particularly a pedestrian) by performing the process described above. The processor 110 of the vehicle control apparatus 100 may more accurately identify the distance and location of an external object, thereby preventing accidents if a vehicle is driving while a driving assistance function or autonomous driving function of the vehicle including the vehicle control apparatus 100 is activated.

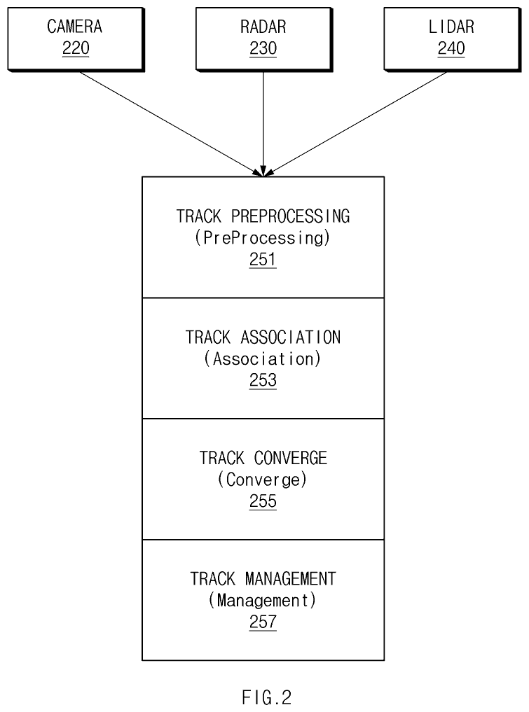

FIG. 2 shows an example of a block diagram associated with processing of a track, in an example of the present disclosure.

Referring to FIG. 2, a processor (e.g., the processor 110 in FIG. 1) of a vehicle control apparatus (e.g., the vehicle control apparatus 100 in FIG. 1) according to an example may obtain tracks or track information corresponding to an external object through a camera 220 (e.g., the camera 120 in FIG. 1), a RADAR 230 (e.g., the RADAR 130 in FIG. 1), and/or a LiDAR 240 (e.g., the LiDAR 140 in FIG. 1).

For example, the processor may obtain a camera track through the camera 220. For example, the processor may obtain a RADAR track or RADAR track information through the RADAR 230. For example, the processor may obtain a LiDAR track or LiDAR track information through the LiDAR 240.

In an example, the processor may perform track preprocessing 251 on tracks obtained through the camera 220, the RADAR 230, and/or the LiDAR 240. For example, the track preprocessing 251 may include a process of removing at least one track of which the reliability is smaller than the reference reliability, based on the FOV of the camera 220, the RADAR 230, and/or the LiDAR 240.

In an example, the processor may perform a track association 253 based on performing the track preprocessing 251. For example, the track association 253 may include a process of selecting one of the camera 220, the RADAR 230, and the LiDAR 240 as a reference sensor, performing an association of tracks of target sensors different from the reference sensor on the basis of a track based on the selected reference sensor, and forming a sensor track cluster. For example, the sensor track cluster may include a group indicating a specific external object.

In an example, the processor may perform track converge 255 based on performing the track association 253. For example, the track converge 255 may include a process of generating an output track used in a driving assistance mode or autonomous driving mode of the vehicle, by converging information of the sensor track cluster generated based on the track association 253.

In an example, the processor may perform track management 257 based on performing the track converge 255. For example, the track management 257 may include a process of managing an output track generated by the track converge 255.

As mentioned above, the processor of the vehicle control apparatus according to an example may perform various processes on tracks obtained through the camera 220, the RADAR 230, and/or the LiDAR 240, thereby providing assistance in preventing accidents by accurately identifying an external object if the vehicle is operating in a driving assistance mode or an autonomous driving mode.

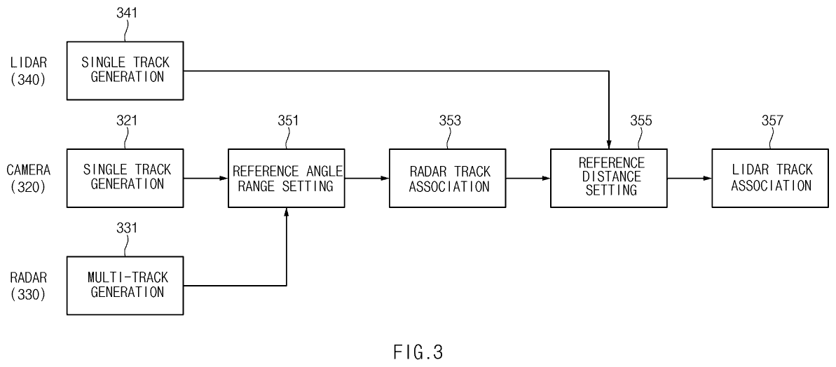

FIG. 3 shows an example of a block diagram associated with tracks generated by each sensor, in an example of the present disclosure.

A processor (e.g., the processor 110 in FIG. 1) of a vehicle control apparatus (e.g., the vehicle control apparatus 100 in FIG. 1) according to an example may obtain tracks or track information corresponding to an external object based on a camera 320 (e.g., the camera 120 in FIG. 1), a RADAR 330 (e.g., the RADAR 130 in FIG. 1), and/or a LiDAR 340 (e.g., the LiDAR 140 in FIG. 1).

In an example, the camera 320 may perform single track generation 321 based on a visual object corresponding to the external object identified within an image. For example, the camera 320 may generate a camera track or camera track information based on the single track generation 321.

In an example, the RADAR 330 may perform multi-track generation 331 based on RADAR plots corresponding to an external object. For example, the RADAR 330 may generate RADAR tracks or RADAR track information based on the multi-track generation 331. The processor may set one of the generated RADAR tracks or one of the RADAR plots as a reference RADAR track.

In an example, the LiDAR 340 may perform single track generation 341 based on the point cloud or virtual box corresponding to the external object. For example, the LiDAR 340 may generate a LiDAR track or LiDAR track information based on the single track generation 341.

In an example, the processor may perform a process associated with a reference angle range setting 351 based on the camera track by the camera 320. For example, the processor may perform a process associated with the reference angle range setting 351 around the camera track.

In an example, the processor may perform an association on the camera track and the RADAR track based on performing the process associated with the reference angle range setting 351. For example, the processor may perform RADAR track association 353 for performing an association on the camera track and the RADAR track.

In an example, the processor may perform a reference distance setting 355 based on the RADAR track.

In an example, the processor may perform a LiDAR track association 357 for performing an association on the RADAR track and the LiDAR track based on performing the reference distance setting 355.

Details regarding the reference angle range setting 351 and/or the reference distance setting 355 described above will be described later.

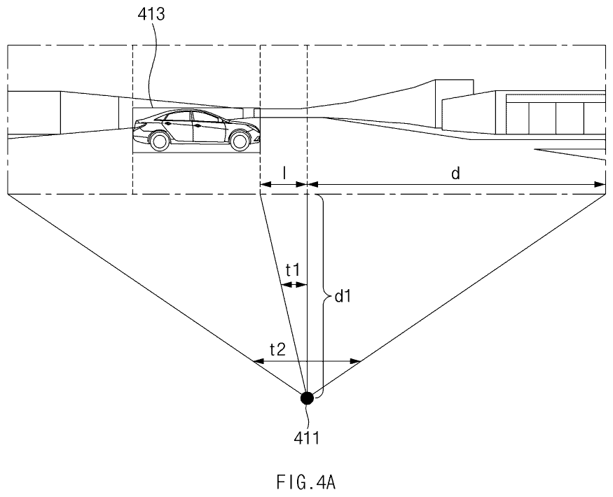

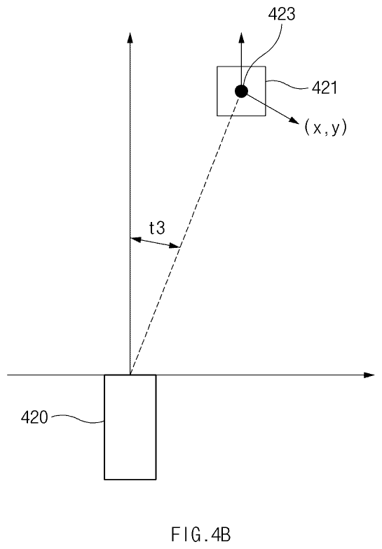

FIGS. 4A and 4B show an example for setting a reference angle or reference angle range, in an example of the present disclosure.

Referring to FIGS. 4A and 4B, a processor (e.g., the processor 110 in FIG. 1) of a vehicle control apparatus (e.g., the vehicle control apparatus 100 of FIG. 1) according to an example may obtain an image through a camera (e.g., the camera 120 in FIG. 1).

Referring to FIG. 4A, in an example, the processor may identify a reference angle t1 based on the image. For example, the processor may calculate a reference angle t1 based on at least one of a focus 411 of a camera, a focus distance d1, FOV t2 of the camera, a first length ‘d’ between the center of the image and an end of the image, or a second length ‘l’ between the center of the image and an end of a camera track 413, or any combination thereof.

For example, the processor may identify the reference angle t1 based on Equation 1 below.

$$t 1 = {tan}^{- 1} ( \frac{l \times tan ( \frac{t 2}{2} )}{d} ) \qquad [ Equation 1 ]$$

As described previously, t1 in Equation 1 may include the reference angle t1. ‘l’ in Equation 1 may include the second length ‘l’ between the center of the image and the end of the camera track 413. ‘d’ in Equation 1 may include the first length ‘d’ between the center of the image and the end of the image. ‘t2’ in Equation 1 may include the FOV t2 of the camera.

As mentioned above, the processor may calculate a reference angle t1 by using Equation 1 based on the camera track output in a form of a bounding box included in the image. Referring to FIG. 4B, the processor of the vehicle control apparatus according to an example may calculate a reference angle t3 in a vehicle coordinate system formed based on a vehicle 420. For example, the vehicle coordinate system formed based on the vehicle 420 may be expressed as a bird-eye-view (BEV). For example, the processor may identify a camera track 421 corresponding to an external object. A bird-eye view may be taken a view above a certain distance from a ground and/or an object and may capture an area larger than a threshold. A bird-eye view image may indicate (and/or may be associated with) a perspective angle from a vehicle (e.g., row, yaw, pitch information of the vehicle and/or one or more cameras of the vehicle). A bird-eye view image may indicate (and/or may be associated with) time information and/or other indicators of a frame of the bird-eye view image. A bird-eye view image may indicate (and/or may be associated with) one or more landmark images included in the bird-eye view image.

The processor may identify center coordinates 423 of the camera track 421 based on identifying the camera track 421. For example, the center coordinates 423 of the camera track 421 may be expressed as (x, y). For example, the x-coordinate of the center coordinates 423 may include a coordinate of the x-axis representing a value that increases toward the front of the vehicle 420. For example, the y-coordinate of the center coordinates 423 may include a coordinate of the y-axis representing a value that increases toward the left side of the vehicle 420.

In an example, the processor may calculate the reference angle t3 based on Equation 2 below.

$$t 3 = {tan}^{- 1} ( \frac{y}{x} ) \qquad [ Equation 2 ]$$

As described previously, t3 in Equation 2 may include the reference angle t3. ‘x’ in Equation 2 may refer to the x coordinate included in the center coordinates 423 of the camera track 421. ‘y’ in Equation 2 may refer to the y coordinate included in the center coordinates 423 of the camera track 421.

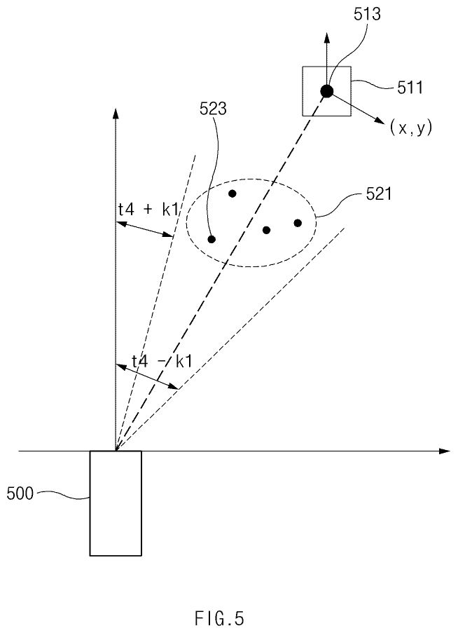

As described above, the processor of the vehicle control apparatus according to an example may calculate the reference angle t3 based on the camera track 421. The processor may perform an association on the camera track 421 and the RADAR track by performing processes described below based on calculating the reference angle t3. Hereinafter, an example of performing an association on the camera track 421 and the RADAR track will be described with reference to FIG. 5. Because angle information of the camera is relatively more accurate compared to the RADAR and/or the LiDAR, the camera may provide assistance in identifying the exact location of the external object by setting the reference angle t3 based on the camera track 421.

FIG. 5 shows an example of associating a camera track and a RADAR track, in an example of the present disclosure.

Referring to FIG. 5, a processor (e.g., the processor 110 in FIG. 1) of a vehicle control apparatus (e.g., the vehicle control apparatus 100 of FIG. 1) according to an example may perform an association on a camera track 511 and a RADAR track 523.

In an example, as described in FIGS. 4A and 4B, the processor may calculate or determine a reference angle t4 based on a center coordinates 513 of the camera track 511.

In an example, the processor may identify or determine an angle resolution of a RADAR (e.g., the RADAR 130 in FIG. 1). The processor may identify a reference angle range including a radius, which rotates clockwise and/or counterclockwise by a designated angle (e.g., k1) from the reference angle t4, based on the angle resolution of the RADAR. For example, the reference angle range may be referred to as an “angle gate”. For example, the reference angle range may include a range between t4+k1 and t4-k1.

In an example, the processor may identify RADAR plots 521, which are included within the reference angle range, from among the RADAR plots 521 (or RADAR tracks) obtained through the RADAR. Hereinafter, for convenience of description, the RADAR plots and RADAR tracks are described separately, but the RADAR plots 521 may include RADAR tracks.

For example, a k1 value may be set differently depending on the angle resolution of the RADAR. For example, as the angle resolution of the RADAR is higher (i.e., as the angle resolution of the RADAR is smaller), the k1 value may be set to be smaller. For example, as the angle resolution of the RADAR is lower (i.e., as the angle resolution of the RADAR is greater), the k1 value may be set to be greater. Moreover, the k1 value may be set by applying a designated margin to the angle resolution of the RADAR.

In an example, the processor may identify a RADAR plot, which is closest to a vehicle 500, from among the RADAR plots 521 included within the reference angle range. For example, the processor may select the identified RADAR plot as the camera track 511 for performing an association on the RADAR track 523, based on identifying the RADAR plot with the closest straight line distance from the vehicle 500 among the RADAR plots 521.

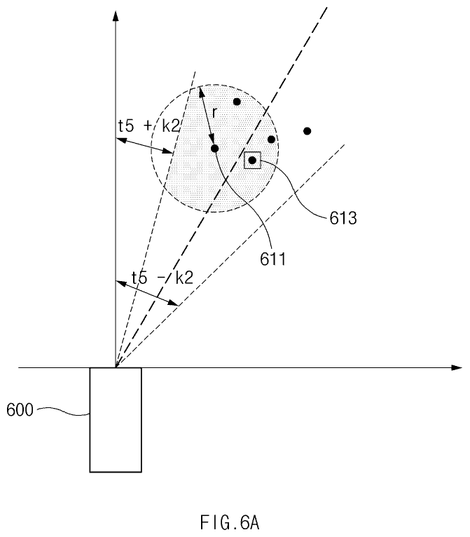

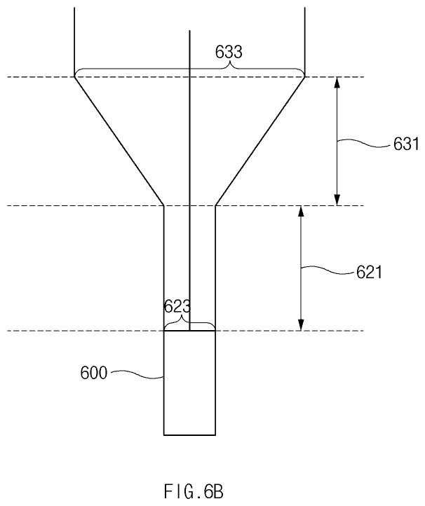

As described above, the processor of the vehicle control apparatus according to an example may perform an association on the camera track 511 and the RADAR track 523, based on selecting the RADAR track 523 for performing an association on the camera track 511. The processor may perform the association on the camera track 511 and the RADAR track 523, may set a reference distance from the RADAR track 523 based on the RADAR track 523, and may identify a LiDAR track for performing an association on the camera track 511 and/or the RADAR track 523 based on the set reference distance. Hereinafter, an example of identifying a LiDAR track for performing an association on the camera track 511 and/or the RADAR track 523 will be described with reference to FIGS. 6A and 6B.

FIGS. 6A and 6B show an example of setting a reference distance from a RADAR track, in an example of the present disclosure.

Referring to FIGS. 6A and 6B, a processor (e.g., the processor 110 in FIG. 1) of a vehicle control apparatus (e.g., the vehicle control apparatus 100 of FIG. 1) according to an example may identify a reference distance ‘r’ based on a RADAR track 611.

Referring to FIG. 6A, the processor of the vehicle control apparatus according to an example may set the reference distance ‘r’ based on a location of the RADAR track 611. For example, the processor may set the reference distance ‘r’ based on a longitudinal distance at which the RADAR track 611 is spaced from a vehicle 600.

Referring to FIG. 6B, the processor of the vehicle control apparatus according to an example may set the reference distance ‘r’ as a first reference distance 623 (e.g., about 1 m) based on a RADAR track (e.g., a RADAR track 611 in FIG. 6A, hereinafter, referred to as the “RADAR track 611”) being located within a first longitudinal distance 621 (e.g., about 30 m) from the vehicle 600.

In an example, the processor may variably set the reference distance ‘r’ based on the RADAR track 611 being located between the first longitudinal distance 621 and a second longitudinal distance 631 (e.g., about 60 m).

In an example, the processor may gradually increase the reference distance ‘r’ between the first longitudinal distance 621 and the second longitudinal distance 631. For example, the processor may set the reference distance ‘r’ as a second reference distance 633 at the second longitudinal distance 631 exceeding the first reference distance 623, by gradually increasing the reference distance ‘r’ from the first reference distance 623 based on the longitudinal distance of the RADAR track 611 exceeding the first longitudinal distance 621 and being smaller than or equal to the second longitudinal distance 631.

Returning to FIG. 6A, the processor of the vehicle control apparatus according to an example may identify a LiDAR track 613 within the reference distance ‘r’ based on setting the reference distance ‘r’ from the RADAR track 611. In an example, the processor may perform an association on the RADAR track 611 and the LiDAR track 613 based on identifying the LiDAR track 613 within the reference distance ‘r’ from the RADAR track 611.

For example, the processor may perform an association on the LiDAR track 613 and the RADAR track 611, which are identified within the reference distance ‘r’ from the RADAR track 611 and which are identified within the reference angle range. For example, the reference angle range may include a range between t5+k2 and t5-k2.

As described above, the processor of the vehicle control apparatus according to an example may set the reference distance ‘r’ based on the RADAR track 611, may perform an association on the LiDAR track 613 and the RADAR track 611 within the set reference distance ‘r’, and thus may obtain a sensor track cluster with relatively accurate location information. Because distance information of the RADAR is relatively accurate compared to the camera and/or the LiDAR, the RADAR may provide assistance in identifying the exact distance of the external object by setting the reference distance ‘r’ based on the RADAR track 611.

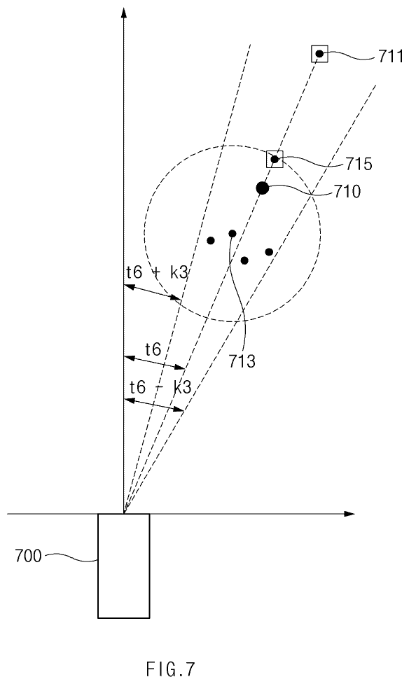

FIG. 7 shows an example of performing an association on a camera track, a RADAR track, and a LiDAR track corresponding to an external object, in an example of the present disclosure.

Referring to FIG. 7, a processor (e.g., the processor 110 in FIG. 1) of a vehicle control apparatus (e.g., the vehicle control apparatus 100 of FIG. 1) according to an example may obtain a camera track 711 corresponding to an external object 710 through a camera (e.g., the camera 120 in FIG. 1). In an example, the processor may obtain a RADAR track 713 corresponding to the external object 710 through a RADAR (e.g., the RADAR 130 in FIG. 1). In an example, the processor may obtain a LiDAR track 715 corresponding to the external object 710 through a LiDAR (e.g., the LiDAR 140 in FIG. 1).

In an example, the processor may calculate or determine a reference angle t6 based on the center coordinates of the camera track 711. The processor may set a reference angle range based on the angle resolution of the RADAR. For example, the reference angle range may include a range between t6+k3 and t6-k3.

In an example, the processor may select the RADAR plot closest to a vehicle 700 among the RADAR plots included within the reference angle range as the RADAR track 713, and may perform an association on the selected RADAR track 713 and the camera track 711.

In an example, the processor may set a reference distance based on the longitudinal distance of the RADAR track 713 from the vehicle 700. The processor may identify the LiDAR track 715 within the set reference distance. The processor may perform an association on the RADAR track 713 and the LiDAR track 715 based on identifying the LiDAR track 715 within the reference distance from the RADAR track 713.

As described above, the processor of the vehicle control apparatus according to an example may set the reference angle range based on the camera track 711, may set the reference distance based on the RADAR track 713, and thus may perform an association on the camera track 711, the RADAR track 713, and/or the LiDAR track 715. The processor may identify the exact location of the external object 710 by performing the above-described processes. The processor may prevent accidents if the vehicle 700 is driven in a driving assistance mode or autonomous driving mode by identifying the exact location or more accurate location of the external object 710.

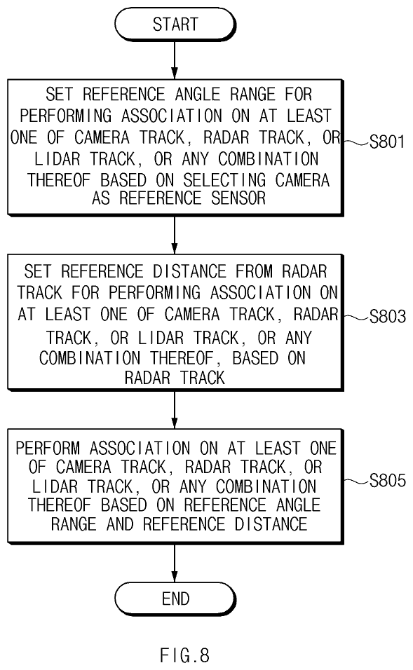

FIG. 8 shows an example of a flowchart associated with a vehicle control method, according to an example of the present disclosure.

Hereinafter, it is assumed that the vehicle control apparatus 100 of FIG. 1 performs the process of FIG. 8. In addition, in a description of FIG. 8, it may be understood that an operation described as being performed by an apparatus is controlled by the processor 110 of the vehicle control apparatus 100.

At least one of operations of FIG. 8 may be performed by the vehicle control apparatus 100 of FIG. 1. At least one of operations of FIG. 8 may be performed by the processor 110 of FIG. 1. Each of the operations in FIG. 8 may be performed sequentially, but is not necessarily sequentially performed. For example, the order of operations may be changed, and at least two operations may be performed in parallel.

Referring to FIG. 8, in S801, a vehicle control method according to an example may include an operation of setting a reference angle range for performing an association forming a group of at least one of a camera track, a RADAR track, or a LiDAR track, or any combination thereof based on selecting a camera as a reference sensor.

For example, the camera track may include a visual object corresponding to the external object within an image obtained through the camera.

For example, the RADAR track may include a RADAR plot corresponding to the external object among the RADAR plots obtained through the RADAR.

For example, the LiDAR track may include a point cloud or virtual box, which corresponds to an external object, from among point clouds or virtual boxes obtained through the LiDAR.

The vehicle control method according to an example may include an operation of identifying a RADAR plot, which is included within the reference angle range and which is identified at the closest distance from a vehicle, from among the RADAR plots obtained through the RADAR as the RADAR track. The vehicle control method may include an operation of performing an association on the identified RADAR track and the camera track.

The vehicle control method according to an example may include an operation of performing an association on at least one of the LiDAR track, the camera track, or the RADAR track, or any combination thereof based on identifying the LiDAR track, which is included within the reference angle range and which is included within the reference distance from the RADAR track.

The vehicle control method according to an example may include an operation of identifying the camera track based on a first axis expressing a value increasing towards a front of a vehicle, and a second axis expressing a value increasing towards a left side of the vehicle in a vehicle coordinate system expressed based on the vehicle. The vehicle control method may include an operation of calculating a reference angle for setting a reference angle range based on the center coordinates of the camera track.

The vehicle control method according to an example may include an operation of setting the reference angle range based on the angle resolution of the RADAR and the center coordinates of the camera track. The vehicle control method may include an operation of performing an association on the camera track and the RADAR track, based on identifying the RADAR track within the reference angle range from the camera track.

In S803, the vehicle control method according to an example may include an operation of setting a reference distance from the RADAR track for performing an association on at least one of the camera track, the RADAR track, or the LiDAR track, or any combination thereof, based on the RADAR track.

The vehicle control method according to an example may include an operation of setting the reference distance based on a location resolution of the LiDAR and a longitudinal distance from a vehicle of the RADAR track.

For example, the vehicle control method may include an operation of setting the reference distance as a first reference distance based on the longitudinal distance from the vehicle of the RADAR track being smaller than or equal to a first longitudinal distance. For example, the vehicle control method may include an operation of setting the reference distance as a second reference distance exceeding the first reference distance at a second longitudinal distance, by gradually increasing the reference distance from the first reference distance based on the longitudinal distance exceeding the first longitudinal distance and being smaller than or equal to the second longitudinal distance.

In S805, the vehicle control method according to an example may include an operation of performing an association on at least one of the camera track, the RADAR track, or the LiDAR track, or any combination thereof based on the reference angle range and the reference distance.

The vehicle control method according to an example may include an operation of assigning a first identifier indicating that the camera is the reference sensor, to the camera track.

The vehicle control method may include an operation of assigning a second identifier indicating that the RADAR is a target sensor different from the reference sensor, to the RADAR track. The vehicle control method may include an operation of assigning a second identifier or a third identifier indicating that the LiDAR is the target sensor, to the LiDAR track.

The vehicle control method according to an example may include an operation of assigning at least one of a sensor flag indicating that the camera track, the RADAR track, and the LiDAR track are associated, a data structure, or an identifier, or any combination thereof to the camera track, the RADAR track, and the LiDAR track based on performing an association on the camera track, the RADAR track, and the LiDAR track.

As described above, the vehicle control method according to an example may include an operation of setting a reference angle range by using a camera as a reference sensor and performing an association on the identified RADAR track with the camera track within the set reference angle range. Moreover, the vehicle control method may include an operation of setting a reference distance based on the RADAR track and performing an association on the LiDAR track with the RADAR track and camera track based on the set reference distance. The vehicle control method may accurately identify the location of an external object (particularly a pedestrian) by performing the above-described operations (or processes). Furthermore, the vehicle control method may prevent accidents if the vehicle is operating in a driving assistance mode or autonomous driving mode by accurately identifying the location of an external object.

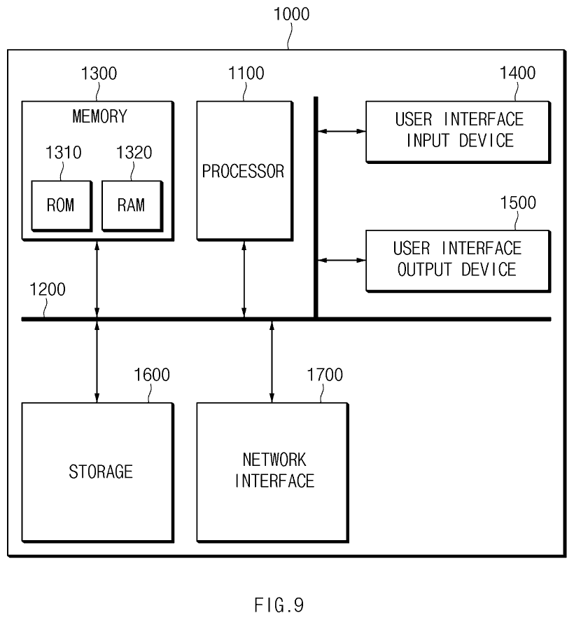

FIG. 9 shows an example of a computing system associated with a vehicle control apparatus or vehicle control method, according to an example of the present disclosure.

Referring to FIG. 9, a computing system 1000 may include at least one processor 1100, a memory 1300, a user interface input device 1400, a user interface output device 1500, a storage 1600, and a network interface 1700, which are connected with each other via a bus 1200. The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random access memory (RAM).

Accordingly, the operations of the method or algorithm described in connection with the examples disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The present disclosure was made to solve the above-mentioned problems occurring in the prior art while advantages achieved by the prior art are maintained intact.

An example of the present disclosure provides a vehicle control apparatus that may accurately identify a location of an external object (in particular, a pedestrian) and a distance from a vehicle by using a camera as a reference sensor, and a method thereof.

An example of the present disclosure provides a vehicle control apparatus that may accurately detect the location of the external object based on each of tracks corresponding to the external object by performing an association on tracks obtained through various sensors, and a method thereof.

An example of the present disclosure provides a vehicle control apparatus that may accurately output a dynamic object fusion (DOF) track of the external object by identifying the location of the external object and the distance from the vehicle to the external object based on performing an association on tracks obtained through various sensors, and a method thereof.

The technical problems to be solved by the present disclosure are not limited to the aforementioned problems, and any other technical problems not mentioned herein will be clearly understood from the following description by those skilled in the art to which the present disclosure pertains.

According to an example of the present disclosure, a vehicle control apparatus may include a camera that obtains a camera track corresponding to an external object (e.g., other vehicles, pedestrians, animals, traffic signals/signs, road debris, construction zones, barricades/obstacles, benches, bus shelters, garbage cans, parked cars, bridges, overpasses, tunnels, etc.), a radio detection and ranging (RADAR) that obtains a RADAR track corresponding to the external object, a light detection and ranging (LiDAR) that obtains a LiDAR track corresponding to the external object, and a processor. The processor may set a reference angle range for performing an association forming a group of at least one of the camera track, the RADAR track, or the LiDAR track, or any combination thereof based on selecting the camera as a reference sensor, may set a reference distance from the RADAR track for performing an association on at least one of the camera track, the RADAR track, or the LiDAR track, or any combination thereof based on the RADAR track, and may perform an association on at least one of the camera track, the RADAR track, or the LiDAR track, or any combination thereof based on the reference angle range and the reference distance. The camera track may include a visual object corresponding to the external object within an image obtained through the camera. The RADAR track may include a RADAR plot corresponding to the external object among RADAR plots obtained through the RADAR. The LiDAR track may include a point cloud or virtual box, which corresponds to the external object, from among point clouds or virtual boxes obtained through the LiDAR.

In an example, the processor may identify a RADAR plot, which is included within the reference angle range and which is identified at the closest distance from a vehicle, from among the RADAR plots obtained through the RADAR as the RADAR track, and may perform an association on the identified RADAR track and the camera track.

In an example, the processor may perform an association on at least one of the LiDAR track, the camera track, or the RADAR track, or any combination thereof based on identifying the LiDAR track, which is included within the reference angle range and which is included within the reference distance from the RADAR track.

In an example, the processor may calculate a reference angle for setting the reference angle range, based on at least one of a first length between a center of the image obtained through the camera and an end of the image, a second length between the center of the image and an end of the camera track, or a field of view (FOV) of the camera, or any combination thereof.

In an example, the processor may identify the camera track based on a first axis expressing a value increasing towards a front of a vehicle, and a second axis expressing a value increasing towards a left side of the vehicle in a vehicle coordinate system expressed based on the vehicle, and may calculate a reference angle for setting the reference angle range based on center coordinates of the camera track.

In an example, the processor may set the reference angle range based on an angle resolution of the RADAR and center coordinates of the camera track, and may perform an association on the camera track and the RADAR track, based on identifying the RADAR track within the reference angle range from the camera track.

In an example, the processor may set the reference distance based on a location resolution of the LiDAR and a longitudinal distance from a vehicle of the RADAR track.

In an example, the processor may set the reference distance as a first reference distance based on the longitudinal distance from the vehicle of the RADAR track being smaller than or equal to a first longitudinal distance, and may set the reference distance as a second reference distance exceeding the first reference distance at a second longitudinal distance, by gradually increasing the reference distance from the first reference distance based on the longitudinal distance exceeding the first longitudinal distance and being smaller than or equal to the second longitudinal distance.

In an example, the processor may assign a first identifier indicating that the camera is the reference sensor, to the camera track, may assign a second identifier indicating that the RADAR is a target sensor different from the reference sensor, to the RADAR track, and may assign a second identifier or a third identifier indicating that the LiDAR is the target sensor, to the LiDAR track.

In an example, the processor may assign at least one of a sensor flag indicating that the camera track, the RADAR track, and the LiDAR track are associated, a data structure, or an identifier, or any combination thereof to the camera track, the RADAR track, and the LiDAR track based on performing an association on the camera track, the RADAR track, and the LiDAR track.

According to an example of the present disclosure, a vehicle control method may include setting a reference angle range for performing an association forming a group of at least one of a camera track, a RADAR track, or a LiDAR track, or any combination thereof based on selecting a camera as a reference sensor, setting a reference distance from the RADAR track for performing an association on at least one of the camera track, the RADAR track, or the LiDAR track, or any combination thereof based on the RADAR track, and performing an association on at least one of the camera track, the RADAR track, or the LiDAR track, or any combination thereof based on the reference angle range and the reference distance. The camera track may include a visual object corresponding to an external object within an image obtained through the camera. The RADAR track includes a RADAR plot corresponding to the external object among RADAR plots obtained through a RADAR. The LiDAR track includes a point cloud or virtual box, which corresponds to the external object, from among point clouds or virtual boxes obtained through a LiDAR.

The vehicle control method according to an example may include identifying a RADAR plot, which is included within the reference angle range and which is identified at the closest distance from a vehicle, from among the RADAR plots obtained through the RADAR as the RADAR track, and performing an association on the identified RADAR track and the camera track.

The vehicle control method according to an example may include performing an association on at least one of the LiDAR track, the camera track, or the RADAR track, or any combination thereof based on identifying the LiDAR track, which is included within the reference angle range and which is included within the reference distance from the RADAR track.

The vehicle control method according to an example may include calculating a reference angle for setting the reference angle range, based on at least one of a first length between a center of the image obtained through the camera and an end of the image, a second length between the center of the image and an end of the camera track, or a FOV of the camera, or any combination thereof.

The vehicle control method according to an example may include identifying the camera track based on a first axis expressing a value increasing towards a front of a vehicle, and a second axis expressing a value increasing towards a left side of the vehicle in a vehicle coordinate system expressed based on the vehicle, and calculating a reference angle for setting the reference angle range based on center coordinates of the camera track.

The vehicle control method according to an example may include setting the reference angle range based on an angle resolution of the RADAR and center coordinates of the camera track, and performing an association on the camera track and the RADAR track, based on identifying the RADAR track within the reference angle range from the camera track.

The vehicle control method according to an example may include setting the reference distance based on a location resolution of the LiDAR and a longitudinal distance from a vehicle of the RADAR track.

The vehicle control method according to an example may include setting the reference distance as a first reference distance based on the longitudinal distance from the vehicle of the RADAR track being smaller than or equal to a first longitudinal distance, and setting the reference distance as a second reference distance exceeding the first reference distance at a second longitudinal distance, by gradually increasing the reference distance from the first reference distance based on the longitudinal distance exceeding the first longitudinal distance and being smaller than or equal to the second longitudinal distance.

The vehicle control method according to an example may include assigning a first identifier indicating that the camera is the reference sensor, to the camera track, assigning a second identifier indicating that the RADAR is a target sensor different from the reference sensor, to the RADAR track, and assigning a second identifier or a third identifier indicating that the LiDAR is the target sensor, to the LiDAR track.

The vehicle control method according to an example may include assigning at least one of a sensor flag indicating that the camera track, the RADAR track, and the LiDAR track are associated, a data structure, or an identifier, or any combination thereof to the camera track, the RADAR track, and the LiDAR track based on performing an association on the camera track, the RADAR track, and the LiDAR track.

The above description is merely an example of the technical idea of the present disclosure, and various modifications and modifications may be made by one skilled in the art without departing from the essential characteristic of the present disclosure.

Accordingly, examples of the present disclosure are intended not to limit but to explain the technical idea of the present disclosure, and the scope and spirit of the present disclosure is not limited by the above examples. The scope of protection of the present disclosure should be construed by the attached claims, and all equivalents thereof should be construed as being included within the scope of the present disclosure.

The present technology may more accurately identify a location of an external object (in particular, a pedestrian) and a distance from a vehicle by using a camera as a reference sensor.

Furthermore, the present technology may more accurately detect the location of the external object based on each of tracks corresponding to the external object by performing an association on tracks obtained through various sensors.

Moreover, the present technology may more accurately output a DOF track of the external object by identifying the location of the external object and the distance from the vehicle to the external object based on performing an association on tracks obtained through various sensors.

Besides, a variety of effects directly or indirectly understood through the present disclosure may be provided.

Hereinabove, although the present disclosure was described with reference to examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for controlling a vehicle, the apparatus comprising:
a first sensor configured to obtain first track information associated with an external object, wherein the first track information comprises a visual object corresponding to the external object within an image obtained by the first sensor;
a second sensor configured to obtain second track information associated with the external object, wherein the second track information comprises a plot of a plurality of plots obtained by the second sensor, and wherein the plot corresponds to the external object;
a third sensor configured to obtain third track information associated with the external object, wherein the third track information comprises at least one of a cluster of points of a plurality of clusters of points obtained by the third sensor or a virtual box of a plurality of virtual boxes obtained by the third sensor, and wherein the cluster of points or the virtual box correspond to the external object; and
a processor,
wherein the processor is configured to:
set, based on selecting the first sensor as a reference sensor, a reference angle range;
set, based on the second track information, a reference distance;
associate, based on the reference angle range and the reference distance, at least one of the first track information, the second track information, or the third track information; and
output, based on the association, a signal for controlling the vehicle.

2. The apparatus of claim 1, wherein the processor is configured to:
determine the plot of the plurality of plots, as a part of the second track information, wherein the plot is included within the reference angle range and is at the closest distance from the vehicle; and
associate, based on the determination, the second track information and the first track information.

3. The apparatus of claim 1, wherein the processor is configured to:
associate, based on determining the third track information, at least one of the third track information, the first track information, or the second track information, wherein the third track information indicates that a third track is included within the reference angle range and within the reference distance.

4. The apparatus of claim 1, wherein the processor is configured to:
determine a reference angle for setting the reference angle range based on at least one of:
a first length between a center of the image and an end of the image,
a second length between the center of the image and an end of a first track indicated by the first track information, or
a field of view of the first sensor.

5. The apparatus of claim 1, wherein the processor is configured to:
determine the first track information based on:
a first axis parallel to a driving direction of the vehicle, and
a second axis perpendicular to the first axis; and
determine, based on center coordinates from the first track information, a reference angle for setting the reference angle range.

6. The apparatus of claim 1, wherein the processor is configured to:
set, based on an angle resolution from the second sensor and center coordinates from the first track information, the reference angle range; and
based on determining that a second track, from the second track information, is within the reference angle range from the first track information, associate the first track information and the second track information.

7. The apparatus of claim 1, wherein the processor is configured to:
set, based on a location resolution associated with the third sensor and a longitudinal distance from the vehicle as indicated by the second track information, the reference distance.

8. The apparatus of claim 7, wherein the processor is configured to:
set, based on the longitudinal distance being smaller than or equal to a first longitudinal distance, the reference distance as a first reference distance; and
set, based on the longitudinal distance exceeding the first longitudinal distance and being smaller than or equal to a second longitudinal distance, the reference distance as a second reference distance exceeding the first reference distance at the second longitudinal distance, by gradually increasing the reference distance from the first reference distance.

9. The apparatus of claim 1, wherein the processor is configured to:
assign a first identifier to the first track information, wherein the first identifier indicates that the first sensor is the reference sensor;
assign a second identifier to the second track information wherein the second identifier indicates that the second sensor is a target sensor different from the reference sensor; and
assign the second identifier or a third identifier to the third track information, wherein the second identifier or the third identifier indicate that the third sensor is the target sensor.

10. The apparatus of claim 1, wherein the processor is configured to:
based on associating the first track information, the second track information, and the third track information, assign, to the first track information, the second track information, and the third track information, at least one of:
a sensor flag indicating that the first track information, the second track information, and the third track information are associated,
a data structure, or
an identifier.

11. A method for controlling a vehicle, the method comprising:
setting, by a processor and based on selecting a first sensor as a reference sensor, a reference angle range, wherein first track information, obtained from the first sensor, comprises a visual object corresponding to an external object within an image obtained by the first sensor;
setting, based on a second track information obtained from a second sensor, a reference distance, wherein the second track information comprises a plot of a plurality of plots obtained by the second sensor, and wherein the plot corresponds to the external object;
associating, based on the reference angle range and the reference distance, at least one of first track information obtained from the first sensor, the second track information, or third track information obtained from a third sensor, wherein the third track information comprises at least one of a cluster of points of a plurality of clusters of points obtained by the third sensor or a virtual box of a plurality of virtual boxes obtained by the third sensor, and wherein the cluster of points or the virtual box correspond to the external object; and outputting, based on the associating, a signal for controlling the vehicle.

12. The method of claim 11, further comprising:
determining the plot of the plurality of plots as a part of the second track information, wherein the plot is included within the reference angle range and is at the closest distance from the vehicle; and
associating, based on the determining, the second track information and the first track information.

13. The method of claim 11, further comprising:
associating, based on determining the third track information, at least one of the third track information, the first track information, or the second track information, wherein the third track information indicates that a third track is included within the reference angle range and within the reference distance.

14. The method of claim 11, further comprising:
determining a reference angle for setting the reference angle range based on at least one of:
a first length between a center of the image and an end of the image,
a second length between the center of the image and an end of a first track indicated by the first track information, or
a field of view of the first sensor.

15. The method of claim 11, further comprising:
determining the first track information based on:
a first axis parallel to a driving direction of a vehicle, and
a second axis perpendicular to the first axis; and
determining, based on center coordinates from the first track information, a reference angle for setting the reference angle range.

16. The method of claim 11, further comprising:
setting, based on an angle resolution from the second sensor and center coordinates from the first track information, the reference angle range; and
based on determining that a second track, from the second track information, is within the reference angle range from the first track information, associating the first track information and the second track information.

17. The method of claim 11, further comprising:
setting, based on a location resolution the third sensor and a longitudinal distance from the vehicle as indicated by the second track information, the reference distance.

18. The method of claim 17, further comprising:
setting, based on the longitudinal distance being smaller than or equal to a first longitudinal distance, the reference distance as a first reference distance; or
setting, based on the longitudinal distance exceeding the first longitudinal distance and being smaller than or equal to a second longitudinal distance, the reference distance as a second reference distance exceeding the first reference distance at the second longitudinal distance, by gradually increasing the reference distance from the first reference distance.

19. The method of claim 11, further comprising:
assigning a first identifier to the first track information, wherein the first identifier indicates that the first sensor is the reference sensor; and
assigning a second identifier to the second track information, wherein the second identifier indicates that the second sensor is a target sensor different from the reference sensor or assigning the second identifier or a third identifier to the third track information, wherein the second identifier or the third identifier indicate that the third sensor is the target sensor.

20. The method of claim 11, further comprising:
based on associating the first track information, the second track information, and the third track information, assigning, to the first track information, the second track information, and the third track information, at least one of:
a sensor flag indicating that the first track information, the second track information, and the third track information are associated,
a data structure, or
an identifier.
